(19) United States
(12) Patent Application Publication
(10) Pub. No.: US 2015/0081076 A1
(43) Pub. Date: Mar. 19, 2015

(54) CUSTOMIZATION OF MANUFACTURED ARTICLES RESPONSIVE TO REMOTE CAPTURE OF THREE DIMENSIONAL DATA

(71) Applicant: Americo Fernandes, Winnipeg (CA)

(72) Inventor: Americo Fernandes, Winnipeg (CA)

(21) Appl. No.: 14/486,956

(22) Filed: Sep. 15, 2014

Related U.S. Application Data
(60) Provisional application No. 61/878,482, filed on Sep. 16, 2013.

(51) Int. Cl. B29C 67/00; G06F 17/50

(52) U.S. Cl. CPC B29C 67/0088; G06F 17/50
USPC 700/98

(57) ABSTRACT

The present invention relates to the production of custom articles, and customization of existing articles, responsive to three dimensional data captured remotely. The invention is particularly applicable to the production of custom shoes and inserts for shoes, and can use smart phones to allow users to easily capture information required for custom footwear.

### CROSS REFERENCE TO RELATED APPLICATIONS

The application claims priority to U.S. provisional application 61/878,482, filed Sep. 16, 2013, which is incorporated herein by reference.

### FIELD OF THE INVENTION

The present invention relates to the production of custom articles, and customization of existing articles, responsive to three dimensional (3D) data captured remotely.

### BACKGROUND OF THE INVENTION

Many articles are available to the consumer in only a limited range of configurations. Even when the consumer is presented with a wide array of styles, colors, and sizes, the consumer must still choose among a limited set. The added time and cost for custom or customized articles is often prohibitive for all except the most rudimentary customizations such as monogramming. Even so, the functional requirements of articles such as orthotics can justify the time and expense of having custom measurements and custom manufacture. There is a need for a way to produce necessarily custom articles such as orthotics at lower cost and in lesser time than current methods. Further, there is a need for cost-effective ways to produce custom or customized versions of articles such as shoes and gloves, where a custom fit to a consumer's actual size and shape would provide benefits if the time and cost were acceptable.

U.S. Pat. No. 7,016,824, which is incorporated herein by reference, describes methods and devices for presenting eyeglasses to a prospective customer. An image of the customer is accepted, and then the customer can be presented with images of the customer's face with various eyeglass frame styles, sizes, and colors. The customer can thereby virtually try on many possible products, without having to travel to a physical store that maintains physical inventory of all the possible combinations. The patent, however, is concerned only with the physical appearance of the eyeglass frame; the functional characteristics of the customer (e.g., the lens prescription) are not affected by the system.

### BRIEF DESCRIPTION OF THE DRAWINGS

The accompanying drawings, which are incorporated in and form part of the specification, illustrate the present invention and, together with the description, describe the invention. In the drawings, like elements are referred to by like numbers.

FIG. 1 is a schematic illustration of a foot configured for use with the present invention.

FIG. 2 is a schematic illustration of obtaining a 3D blueprint of the foot with a camera.

FIG. 3 is a schematic illustration of the process of transmitting a customer's 3D blueprint file to a fabricator.

FIG. 4 is a schematic illustration of the process of fabricating an appropriate foot bed for the customer's chosen shoe design.

FIG. 5 is a schematic illustration of the process of fabricating a custom foot bed or shoe in accord with the present invention.

FIG. 6 is a schematic illustration of custom footwear to be delivered to a customer.

### DESCRIPTION OF THE INVENTION

The present invention relates to the production of custom articles, and customization of existing articles, responsive to three dimensional data captured remotely.

The invention will be described in the context of various example embodiments, with various example products. The scope of the invention is not limited to those examples, but extends to all products that can be specified, ordered, or produced according to the teachings herein.

A prospective customer captures information concerning an object to be fitted. Objects to be fitted can include, as examples, feet (for shoes or orthotics), hands (for gloves or handles), teeth (for functional or cosmetic dentistry), head (for helmet or hat fitting), or larger portions of the body (for clothes fittings). Other objects can also be accommodated, including inanimate objects. The user can capture the information using a capture device such as a camera as is common on most mobile phones today. The user can capture a plurality of images of the object, sufficient to allow construction of a three dimensional model of the object, or at least of the portion of the object needed for fitting.

A three dimensional model of the object or object portion can be generated using software techniques known in the art. As an example, photogrammetry software can be use to construct three dimensional models from a plurality of two dimensional images. The three dimensional model can be constructed on the mobile phone, or can be constructed using a remote processing system. The remote processing system can comprise a personal computer to which the user has uploaded the photos, or can be a computing system accessible via a computer network such as the internet.

The quality of the three dimensional model can depend on the images used in its construction. As examples, images that are incomplete or out of focus can complicate construction of the model. Further, images must be acquired from sufficient perspectives to provide the three dimensional data required. The user can be guided in the collection of the images to facilitate capture of data corresponding to an acceptable quality three dimensional model. For example an application running on the user's phone or other image capture device can monitor the images captured and guide the user to additional images that would be useful. For example, the application can provide test instructions, audible instructions, or visible instructions such as illustrations of the approximate outline of the object that would provide a useful images. The monitoring application can also be on a remote computing device, and provide feedback to the user when the user uploads or processes the images, for example by providing text instructions, audible instructions, or graphical feedback. Such feedback can be provided to user immediately, or can be communicated to the user's phone or other image capture device to be communicated when the user returns to capturing images.

The user can specify a type of article to be created. As an example, the user can specify that orthotics (inserts for shoes to provide desired support for a specific foot) are desired. The user can then take photos of the foot of the patient, which can be the user or can be another individual. The resulting three dimensional model can then be fabricated, as examples using conventional techniques or using three dimensional printing techniques. The orthotic article can be delivered to the patient, for example by shipping from a remote fabrication facility, or by hand delivery if the fabrication facility is convenient. For example, a health care office might have a three dimensional printer on site, and perform the process from image capture through fabrication and delivery while the patient is present. As another example, a patient might take the images at home, submit the information on line, and have the custom orthotics insert delivered by conventional package delivery services.

The article can also be customized rather than fabricated entirely in response to the three dimensional model. As an example, the sole of a shoe can be formed partly of a prefabricated based, with a custom top surface to provide the orthotic effect desired. The custom top surface can be formed additively in response to the three dimensional model, or can be produced by material removal in response to the three dimensional model. Such custom material removal can be accomplished by computer controlled machining techniques, as an example.

The article can also be selected from prefabricated articles, with more detailed sizing than can be accommodated in the inventory of a typical store. As an example, there are a limited number of shoe sizes carried by a typical store. Customers must try on shoes from multiple manufacturers, and in multiple sizes, since each brand, style, and size can be different from all others. According to the present invention, a three dimensional model of the customer's foot can be developed instead of the conventional length and width measurements made. The three dimensional model can then be used to select the best fit of brand, style, and size. The customer can reliably order on-line, since the proper fit is assured by the use of the three dimensional model of the customer's own feet. Ordering on-line allows the customer to select from a much larger variety of brands, sizes, and styles than would be feasible to maintain in a neighborhood store.

There are many other articles that can benefit from the present invention. As an example, hats and helmets are typically sold based on a single size—the circumference of the head at a single meridian. People's heads come in a wide range of sizes and shapes, however. According to the present invention, a three dimensional model can be easily developed from a plurality of images of the head. A hat can then be selected, customized, or fabricated based on that model. Applied to safety devices such as helmets, a proper fit can provide not only increased comfort but also enhanced performance and safety of the wearer. A helmet can be fabricated directly responsive to the three dimensional model, or a size can be selected and padding or other inserts fabricated, selected, or configured to provide the desired fit. Additional information can be combined with the three-dimensional model, for example information concerning the intended activity can be used to configure the final performance (e.g., type of horseback riding, or type of skiing, or position played on a football team, or whether a racer rides a motorcycle or drives a car).

As another example, braces for protecting against or facilitating recovery from various injuries can also benefit from the present invention. Braces for ankles, knees, elbows, shoulders, as examples, can be selected, adjusted, or fabricated responsive to three-dimensional models developed from a plurality of images. Prosthetics, either whole or just inserts, can similarly be produced for optimal fit, even as an injured limb heals or grows.

As another example, images of a hand can be used to select, fabricate or customize articles that interface with a hand. Examples include sports equipment such as ski poles, climbing equipment, and baseball gloves; occupational equipment such as hand tools and machine operation controls; and other hand-interfaced articles such as knives, gear shifters, and barbecue implements. A three dimensional model according to the present invention can be developed from images captured by a customer with no special skills or training in fabrication or fitting of the article. The model can then be used to fabricate or customize a handle, as an example, to best fit the geometry of the customer's hand. The customization can be incorporated into the usual fabrication process, for example by a computer controlled machining of the final shape of a knife handle. The customization can also be incorporated into a mold or spacer that is used in the ordinary fabrication, for example by a hand mold or last used to fit a baseball glove. The customization can also be incorporated by additive production techniques such as three-dimensional printing, for example by direct printing of the final shape of a gear shifter handle or a ski pole hand grip portion.

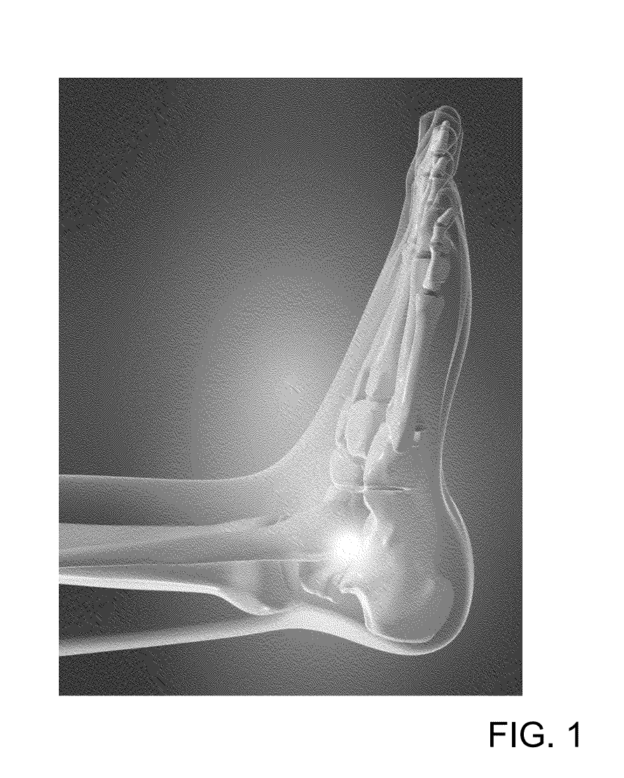

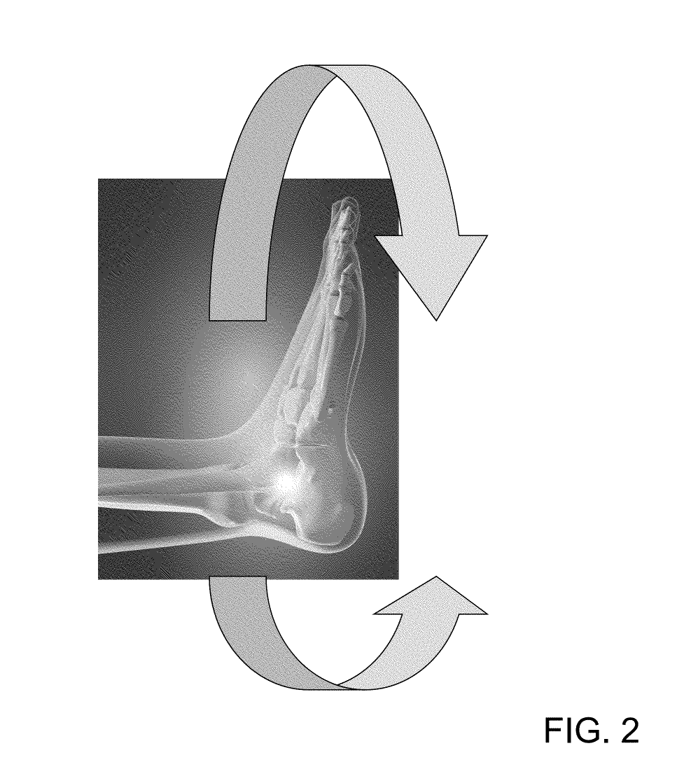

FIGS. 1-6 comprise an illustration of the operation of an example system according to the present invention. The figures illustrate customization of shoe foot bed. The example system is depicted as applied to podiatry. In FIG. 1, a user's foot can be placed on a support such as a stool, chair, or ottoman. This can be done in various locations, including in the user's home or in a store or professional office. If FIG. 2, an image capture device is used to capture images of the foot. The images can be of sufficient number, and taken at sufficient angles, to allow development of a three dimensional model of the foot. Suitable images can be obtained with devise such as cameras commonly in contemporary smart phones. Software on the smartphone can also provide instructions to the user to help ensure that sufficient images are obtained. For example, with a camera, in a circular path, an appropriate series of pictures or video can be obtained, enabling 3D blueprint construction of the foot via a photogrammetric method.

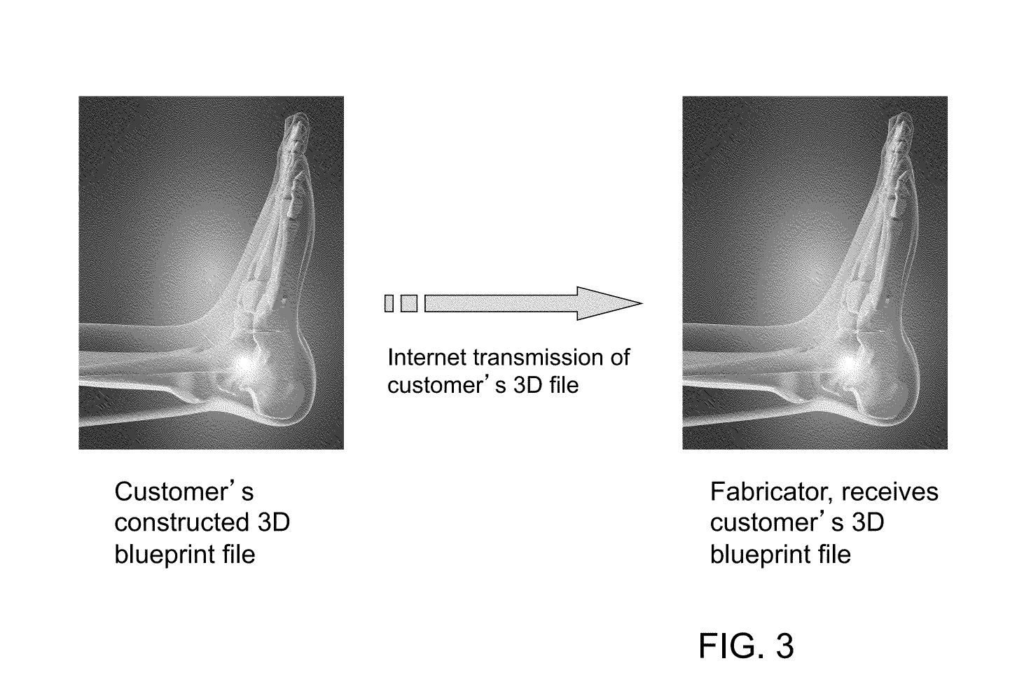

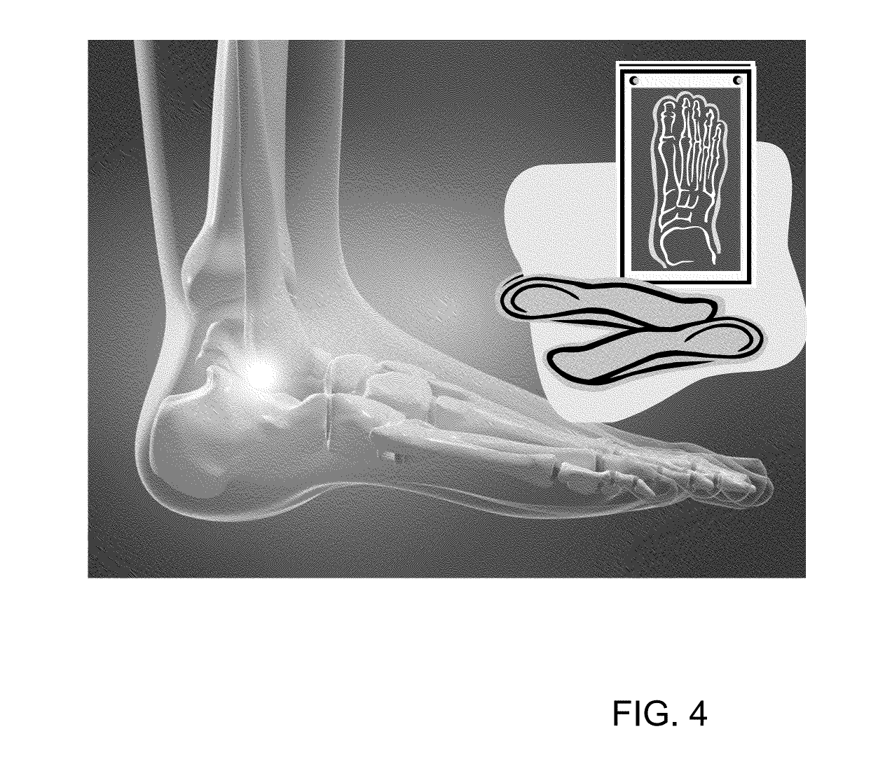

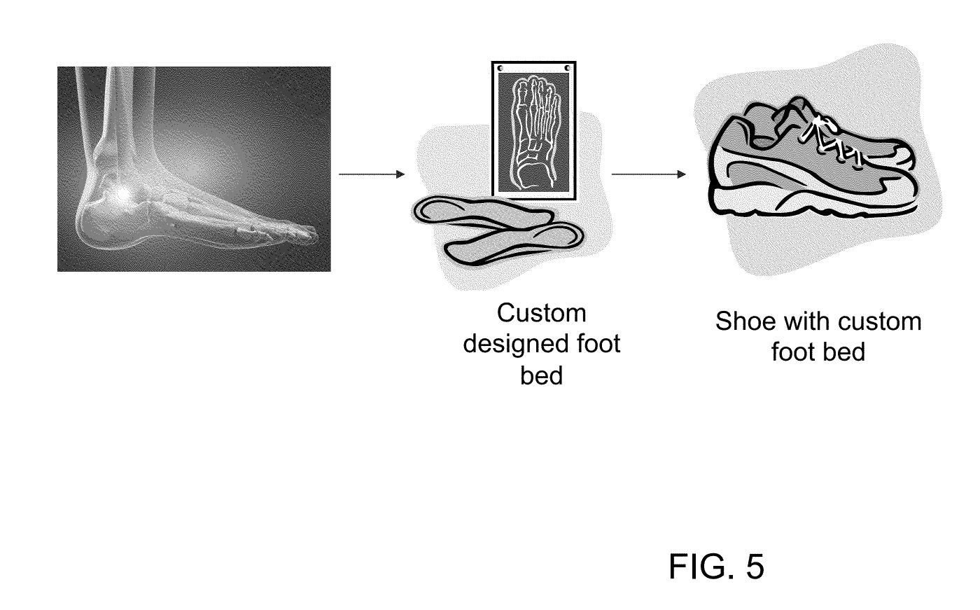

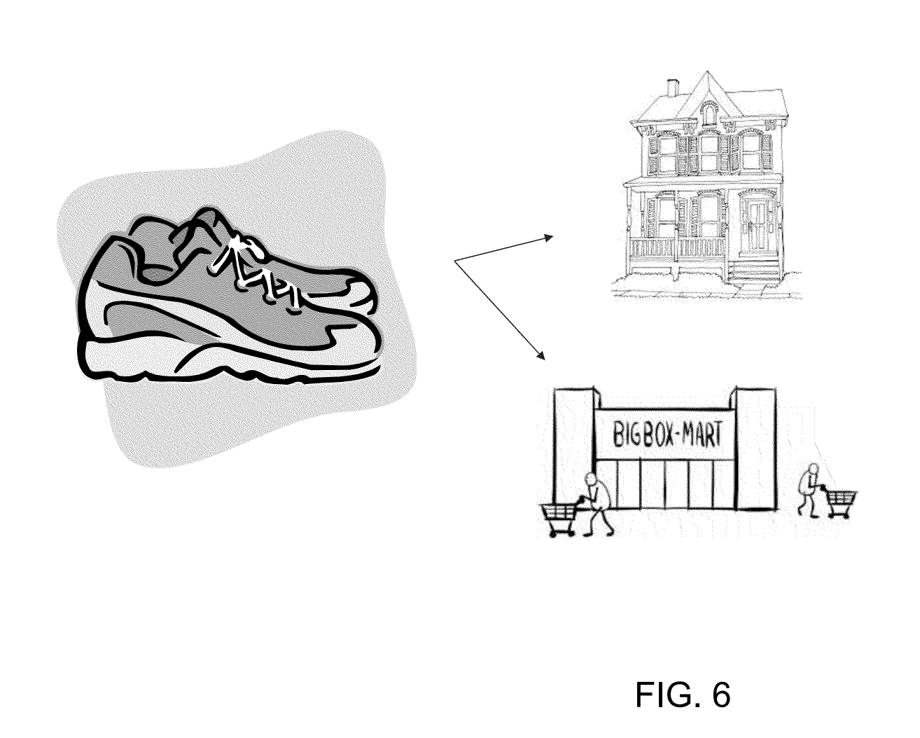

In FIG. 3, the three dimensional model is transmitted to a fabricator. The model can be developed using software on the smartphone, or at an intermediate computing system, or at the fabricator's location. The development of the model can be interactive, with the user or another individual such as the user's doctor refining, modifying, or annotating the model to provide guidance for the fabricator. The model can be transmitted, as an example, using the internet. In FIG. 4, the fabricator produces an ideal foot bed product to fit the user's exact requirements. The fabricator, armed with customer's 3D blueprint file and CAD/CAM technology, can design ideal foot bed for the customer's chosen shoe design (where the foot bed can be an insert or part of the shoe itself). The fabricator can also fabricate foot beds that are less than ideal, but still responsive to the model, for example where the fabricator uses the model to select, customize, or both, from a library of foot bed or shoe sizes or configurations. Fabrication can be accomplished in various ways; starting with a three dimensional computer-readable model can facilitate fabrication using computer controlled processes such as computer-controlled machining or three-dimensional additive printing as depicted in FIG. 5. The product can be an insert that the customer applies to existing footwear, or can be a custom footbed implemented in a newly produced shoe. The insert or shoe can then be delivered to the customer, at the customer's residence, or to a third party such as a shoe store or a professional office, as shown in FIG. 6.

The present invention has been described in the context of various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A system for the production of custom articles, comprising (a) an image capture subsystem, configured to capture a plurality of images of an object, (b) a model development system, configured to develop a three-dimensional model corresponding to at least a portion of the object, responsive to the plurality of images, (c) an article production subsystem, configured to produce an article at least part of which is configured responsive to the three-dimensional model.

2. A system as in claim 1, wherein the image capture subsystem comprises an application running on a mobile device, which application provides information to a user facilitating capture of images suitable for the model development subsystem.

3. A system as in claim 1, wherein the article production subsystem comprises a three-dimensional printer.

4. A system as in claim 1, wherein the article production subsystem comprises a multiaxis CNC machining center.

5. A system as in claim 1, wherein the article is a shoe.

6. A system as in claim 1, wherein the article is an insert for a shoe.

7. A method of producing custom footwear, comprising (a) using a mobile camera to capture a plurality of images of a foot of a customer, (b) using a computing system to produce a three dimensional model of the foot from the plurality of images, (c) producing the custom footwear responsive to the three dimensional model.

8. A method as in claim 7, wherein the mobile camera comprises a smart phone.

9. A method as in claim 7, wherein producing the customer footwear comprises transmitting the three dimensional model from the computing device to a fabrication facility remote from the computing system.
